(19) United States
(12) Patent Application Publication
(10) Pub. No.: US 2003/0227770 A1
(43) Pub. Date: Dec. 11, 2003

(54) Portable illuminating device for connecting with computer

(76) Inventors: Wen-Bin Chen, San Chaung (TW); Yu-Quan Su, St. Taipei (TW)

Correspondence Address: Raymond Sun, 20 Corporate Park, Suite 155, Irvine, CA, 92606, US

(21) Appl. No.: 10/165,943

(22) Filed: Jun. 10, 2002

(51) Int. Cl. F21L 4/04; F21V 21/08

(52) U.S. Cl. 362/85; 362/191; 362/387; 362/197; 362/253

(57) ABSTRACT

An illuminating device has a housing, an illuminating element coupled to a first end of the housing, and a base coupled to a second end of the housing, the base having a clipping mechanism for securing the base to an independent element. A cable is also provided for providing power from a computer device to the illuminating element. The illuminating device can also include a power control unit for switching the supply of power between the computer device and a power source that is retained inside the housing.

### BACKGROUND OF THE INVENTION

1. Field of the Invention

The present invention relates to portable illuminating devices, and in particular, to an illuminating device that can be connected to a desk-top computer, notebook computer, personal digital assistant, or other information appliance having at least one connecting port.

2. Description of the Prior Art

The increased popularity of personal computers (PCs) and similar devices, such as notebook computers, personal digital assistants, or other information appliances, means that consumers can now access and process information at almost any location and at almost any time. As a result, lighting or illumination of the displays for these devices has become an important objective.

Most computer or related devices provide several ports for the communication of signals therebetween, or to provide information or electricity to the computer or related devices.

For example, US Publication No. 2001/0043468 discloses a computer light using IEE1394 or USB port. In addition, WO 01/92781 discloses another computer light device for connecting with a USB port of a notebook computer. Yet another computer illuminating device is further disclosed in U.S. Pat. No. 6,186,636. Unfortunately, these illuminating devices suffer from one or more of the following drawbacks.

First, these illuminating devices provide an adjustable lever or flexible neck for directing the illuminating device at a very small area around the computer. As a result, the effect of the illumination may not be sufficient to adequately illuminate the entire keyboard and display area of the computer device. Second, the adjustable lever or flexible neck typically has one end that connects with a connecting port on the computer device (such as a USB port). Unfortunately, moving or adjusting a flexible or movable lever or neck can compromise the quality of the connection between the end of the lever or neck and the connecting port. Third, the adjustable lever or flexible neck will always need to be re-adjusted when the computer device is set up for use at a different location.

Thus, there still remains a need for an illuminating device that can be conveniently adapted for use with a desk-top computer, notebook computer, personal digital assistant, or other information appliance, which avoids the drawbacks described above.

### SUMMARY OF THE DISCLOSURE

It is an object of the present invention to provide a portable illuminating device having a small size, and which is easy to connect with a computer device.

It is another object of the present invention to provide an ultraviolet illuminating device for detecting fake bills.

In order to accomplish the objects of the present invention, the present invention provides an illuminating device that has a housing, an illuminating element coupled to a first end of the housing, and a base coupled to a second end of the housing, the base having a clipping mechanism for securing the base to an independent element. A cable is also provided for providing power from a computer device to the illuminating element. The illuminating device can also include a power control unit for switching the supply of power between the computer device and a power source that is retained inside the housing.

### BRIEF DESCRIPTION OF THE DRAWINGS

FIG. 1 is an exploded perspective view of an illuminating device according to one embodiment of the present invention.

FIG. 2 is a perspective view of the illuminating device of FIG. 1 shown after it has been assembled.

FIG. 3 is a perspective view illustrating how the illuminating device of FIG. 2 can be connected to a computer device.

FIG. 4 is a block diagram illustrating the components of the illuminating device of FIGS. 1 and 2, and how the illuminating device is connected with a computer port.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

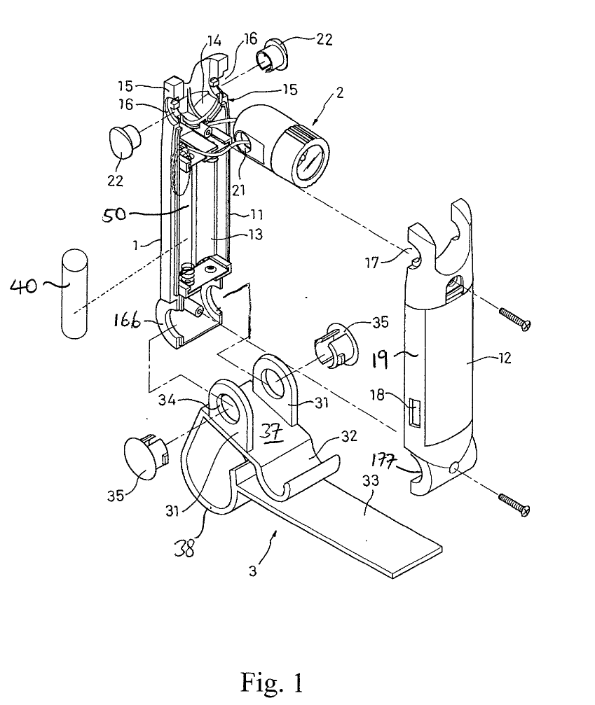

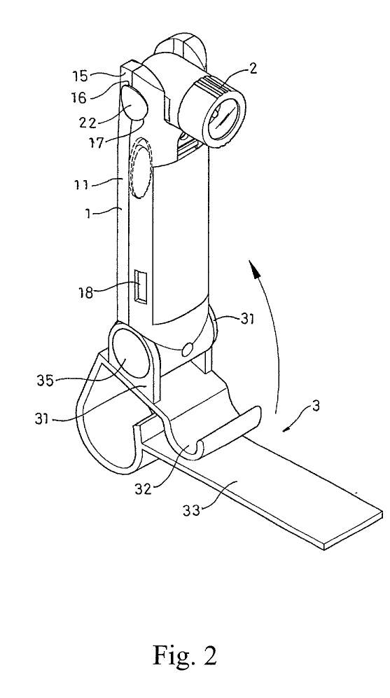

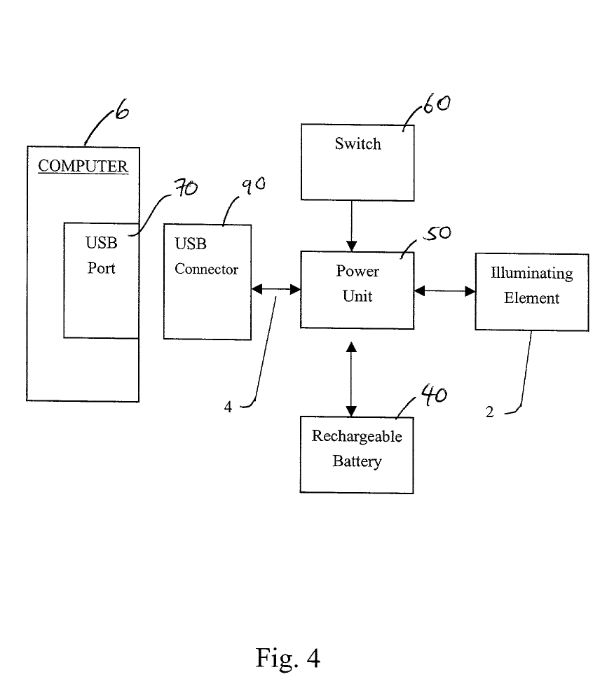

FIGS. 1-3 illustrate one embodiment of a portable illuminating device according to the present invention. The portable illuminating device has a housing 1, an illuminating element 2, and a base 3. The housing 1 has a first housing portion 11 and a second housing portion 12 that together define an interior space. A battery container 13 is provided in the interior space, and functions to retain one or more batteries 40 (which can be normal or rechargeable batteries). Referring also to FIG. 4, a power control unit 50 (which can be a printed circuit board) is also retained in the interior space of the housing 1, with electrical couplings provided within the battery container 13 for electrically coupling the batteries 40 and the power unit 50 to the illuminating element 2. The batteries 40 provide power for the portable illuminating device when it is used outdoors or when the portable illuminating device cannot be coupled with the computer device 6 to be powered by the computer device 6.

The lateral wall 15 of the first housing portion 11 defines two opposing first recesses 16 adjacent its top end, and the lateral wall 19 of the second housing portion 12 defines two opposing second recesses 17 adjacent its top end. Each recess 16 and 17 has a generally semi-circular shape. As a result, each pair of the recesses 16 and 17 together defines a generally circular opening along each side of the housing portions 11 and 12. A cage 14 is defined by the space between the lateral walls 15 of the housing portions 11 and 12 at the location of the recesses 16, 17, with the cage 14 having a shape that corresponds to the shape of the illuminating element 2, so that the illuminating element 2 can be seated in the cage 14.

The illuminating element 2 can be any conventional light source, including an ultraviolet light source, an LED light, and a flourescent light, among others. The illuminating element 2 can be electrically powered by the computer device 6 when the illuminating device is connected via a cable 4 with a communication port 70 of the computer device 6 (see also FIG. 4), and can be electrically powered by the batteries 40 when the cable 4 is separated from the computer device 6. The illuminating element 2 has hole 21 provided along each side, with each hole 21 adapted to receive a corresponding pivot plug 22. In particular, each pivot plug 22 extends through one opening defined by a pair of recesses 16, 17, and into a corresponding hole 21, to create a pivoting connection between the housing 1 and the illuminating element 2.

The lateral wall 15 of the first housing portion 11 also defines two opposing third recesses 166 adjacent its bottom end, and the lateral wall 19 of the second housing portion 12 also defines two opposing fourth recesses 177 adjacent its bottom end. Each recess 166 and 177 has a generally semi-circular shape. As a result, each pair of the recesses 166 and 177 together defines a generally circular opening along each side of the housing portions 11 and 12.

The base 3 has two opposing lateral wings 31 that define an internal space therebetween. The lateral wings 31 are seated on a plate 37, and a curved upper clip 32 extends from a forward edge of the plate 37. A rounded wall 38 extends from the bottom of the plate 37, and a lower clip 33 extends from the front of the rounded wall 38. The lower clip 33 is positioned below the upper clip 32. Opposing and aligned holes 34 are provided on each lateral wing 31. One pivot plug 35 extends through each opening defined by a pair of recesses 166, 177, and into a corresponding hole 34, to create a pivoting connection between the housing 1 and the base 3.

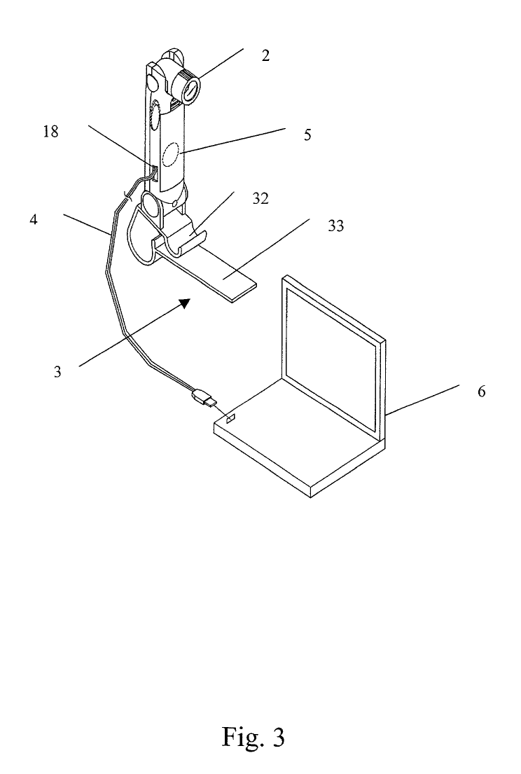

The housing 1 has a plug 18 that is adapted to be electrically connected with a port 70 of a computer device 6 via a cable 4 such that the computer device 6 can provide power via the cable 4 and the plug 18 to power the portable illuminating device. FIG. 3 also shows the provision of a ratchet reel 5 for retracting and holding the cable 4 at a desired length. The port 70 of the computer device 6 can be selected from one of PS2, USB, and IEE 1394, among others. The plug 18 is also electrically connected with the battery container 13 such that the batteries 40 can be recharged. A switch 60 is provided along the housing 1 and is electrically coupled to the power unit 50 to allow the user to turn on and turn off the illuminating element 2.

FIG. 3 illustrates the plug 18 being electrically connected with a cable 4 for use in receiving power from a computer device 6. The upper clip 32 and the lower clip 33 of the base 3 can be used to clip the illuminating device to any desired location (e.g., the desk, the display screen, etc.). When the illuminating element 2 is used as a computer light, the illuminating element 2 will illuminate not only the computer area (i.e., the display and the keyboard), but can also illuminate the neighboring areas. If the filter of the illuminating element 2 is further exchanged to provide an ultraviolet light emitter, then a user may even use the illuminating element 2 to check whether money bills are fake or real.

FIG. 4 is a block diagram illustrating the interconnections of the main components of the portable illuminating device, which includes a power unit 50, a switch 60, rechargeable batteries 40, and an illuminating element 2. The cable 4 has a USB connector 90 to facilitate connection with a USB port 70 of the computer device 6. When the cable 4 is connected with the computer port 70, the power unit 50 will allow the illuminating element 2 to use the power from the computer device 6, and enable the rechargeable batteries 40 to retrieve power therefrom. When the cable 4 is disconnected from the computer port 70, the power unit 50 will allow the batteries 40 to power the illuminating element 2.

Thus, the present invention provides an illuminating device that can be easily adjusted in use, or packed for storage (because the base 3 and illuminating element 2 can be pivoted towards the housing 1 to form a compact and slim configuration). The ability of the illuminating element 2 and the base 3 to pivot allows the user to adjust for appropriate illumination. In addition, the adjustment does not involve twisting or pivoting of the cable 4, so that the connection between the cable 4 and the port 70 will not be compromised.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A computer system, comprising:
a computer device having a port;
an illuminating device, comprising:
a housing separate from the computer device and having a first end, a second end, and a plug;
an illuminating element coupled to the first end of the housing;
a base coupled to the second end of the housing, the base having means for securing the base to an independent element; and
a cable coupling the plug with the port.

2. The system of claim 1, wherein the illuminating device further includes a power source retained in the housing, and a power control unit coupled to the power source and the cable to control the supply of power from either the computer 15 device or the power source.

3. The system of claim 1, wherein the illuminating element is an ultraviolet light emitter.

4. The system of claim 1, wherein the securing means includes an upper clip and a lower clip.

5. The system of claim 1, further including a ratchet reel for retracting the cable.

6. The system of claim 1, wherein the illuminating element is pivotably coupled to the first end of the housing.

7. The system of claim 1, wherein the base is pivotably coupled to the second end of the housing.

8. A computer system, comprising:
a computer device having a port;
an illuminating device, comprising:
a housing having a first end and a second end;
an illuminating element coupled to the first end of the housing;
a base coupled to the second end of the housing, the base having means for securing the base to an independent element; and
means for providing power from the port of the computer device to the illuminating element.

9. The system of claim 8, wherein the illuminating device has a power source retained in the housing, and wherein the providing means includes means for switching the supply of power between the power source and the computer device.

10. The system of claim 8, wherein the illuminating element is pivotably coupled to the first end of the housing.

11. The system of claim 8, wherein the base is pivotably coupled to the second end of the housing.
